(19) United States
(12) Patent Application Publication
(10) Pub. No.: US 2004/0261592 A1
(43) Pub. Date: Dec. 30, 2004

(54) Laser guiding device for table saw machine

(75) Inventor: Jung-Huo Chen, Taichung Hsien (TW)

Correspondence Address: BACON & THOMAS, PLLC, 625 SLATERS LANE, FOURTH FLOOR, ALEXANDRIA, VA, 22314

(73) Assignee: REXON INDUSTRIAL CORP., LTD., Taichung Hsien (TW)

(21) Appl. No.: 10/901,104

(22) Filed: Jul. 29, 2004

(30) Foreign Application Priority Data
May 18, 1993 (TW) 93207765

(51) Int. Cl. B27B 3/28; B27B 5/06

(52) U.S. Cl. 83/520; 362/119

(57) ABSTRACT

A laser guiding device for a table saw machine is connected to a splitter on the work table and includes a carrier in which a laser generating device is received. A power supply member is connected to the splitter and electrically connected to the laser generating device. The laser generating device emits a laser beam which is located in front of the circular blade and is not covered by debris and powder of the object to be cut.

### FIELD OF THE INVENTION

The present invention relates to a laser guiding device connected to the splitter so as to produce a laser beam on the work table to guide the cutting process.

### BACKGROUND OF THE INVENTION

A conventional table saw machine 50 is disclosed in FIG. 5 and generally includes a work table 51 to which a circular blade 52 is connected. The circular blade 52 is connected to a motor which drives the circular blade 52. The motor and a splitter are connected to a shaft located beneath the work table 51 such that when rotating the shaft, the circular blade 52 is tilt an angle. A miter gauge 60 is connected to the top of the work table 51 so that the user may guide the object to be cut at a desired angle. A blade guard 53 is mounted above the circular blade 52 so as to protect the user from being cut by the circular blade 52 and to stop debris or powder produced during the cutting from splashing randomly. Generally, the user has to draw a line on the object and the circular blade 52 is arranged to cut the object along the line. Nevertheless, during the cutting, debris and powder will be coated on the object and the line is usually hidden by the debris and powder. Accordingly, the user has to stop the cutting and blow the debris and powder away to let the line be visible, and then feed the object again. In other words, the cutting is completed with several breaks and this is time consuming.

The present invention intends to provide a laser guiding device which produces a laser beam on the subject and the laser beam will not be covered by the debris and powder during cutting.

### SUMMARY OF THE INVENTION

The present invention relates to a laser guiding device for a table saw machine and the laser guiding device includes a carrier connected to a splitter which is located on the same plane with the circular blade and a laser generating device is received in the carrier. A power supply member is connected to the splitter and electrically connected to the laser generating device so that the laser generating device emits a laser beam which is located in front of the circular blade. The laser beam is visible and not covered by the debris and powder during cutting so as to provide a reliable guidance for the users.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the laser guiding device connected to a table saw machine of the present invention;

FIG. 2 is a side view to show the laser guiding device connected to a table saw machine of the present invention;

FIG. 3 is an exploded view to show the laser guiding device of the present invention;

FIG. 4 is a cross sectional view to show that the laser generating guiding device is received in the carrier, and

FIG. 5 shows a conventional circular blade saw machine.

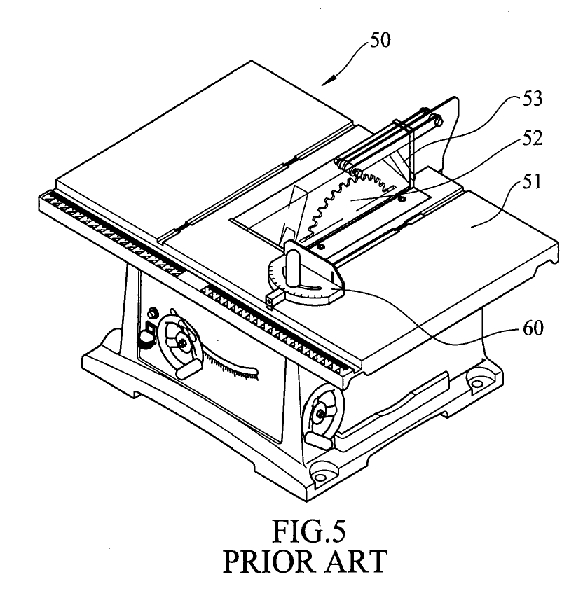

### DETAILED DESCRIPTION OF THE PREFERRED EMBODIMENT

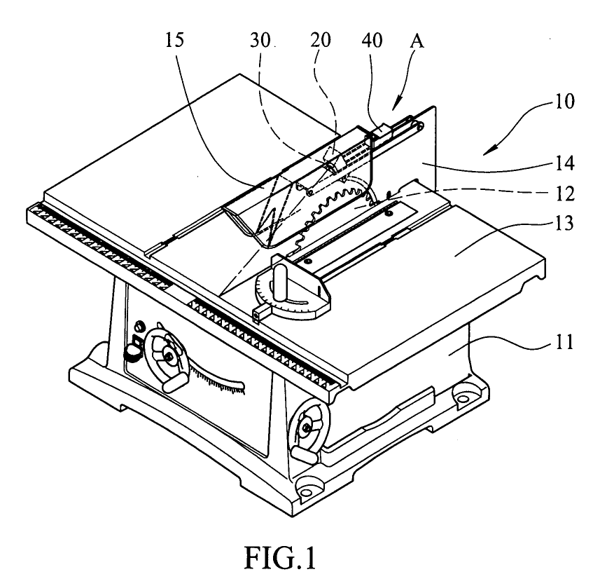

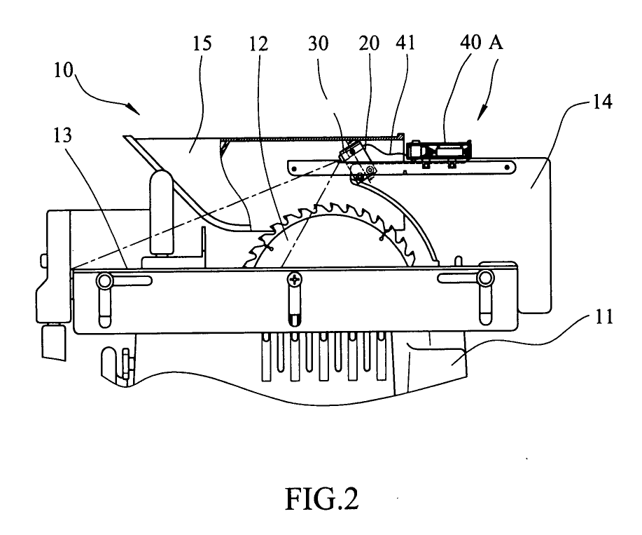

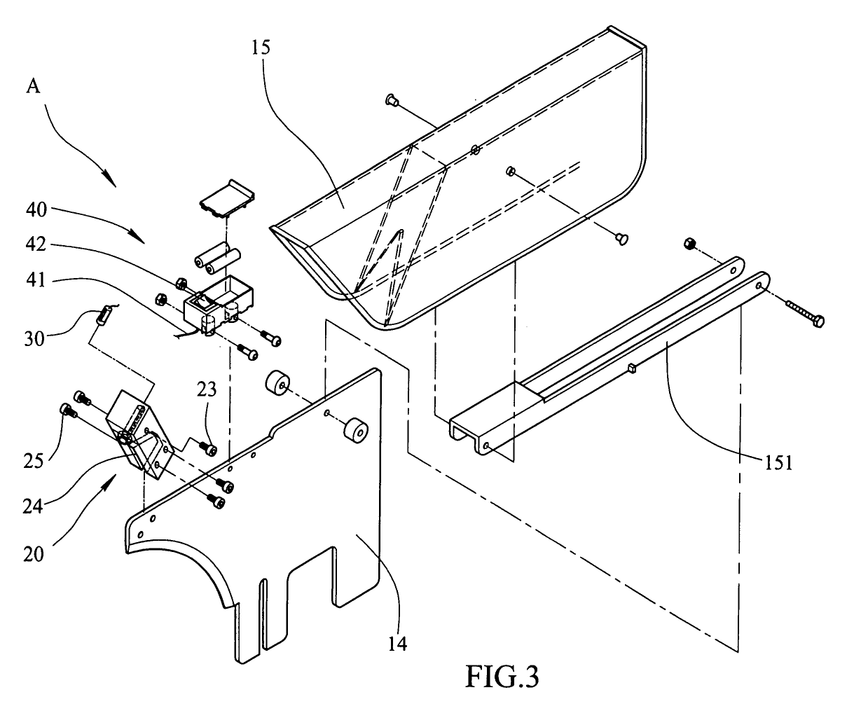

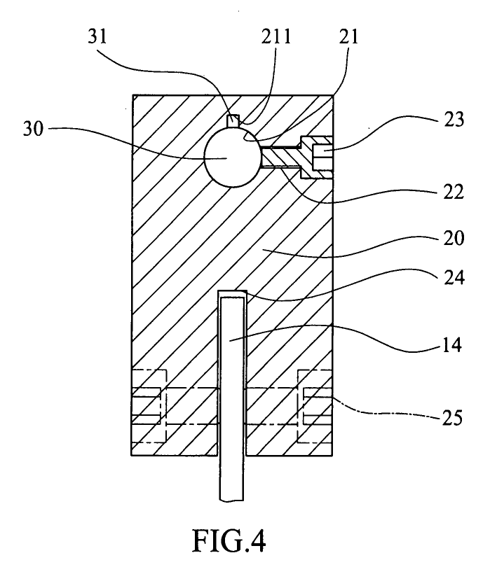

Referring to FIGS. 1 to 4, a table saw machine 10 includes a base 11 on which a work table 13 is connected. A circular blade 12 driven by a motor rotatably extends through a slot defined through the work table 13. The motor and a splitter 14 are connected to a shaft located beneath the work table 13 when the user operates a control wheel (not shown) on a side of the table saw machine 10, the shaft is rotated and splitter 14 and the circular blade 12 can be pivoted as one piece, and located on a common plane with the circular blade 12. A blade guard 15 is pivotably connected to the splitter 14 by a connection member 151 and located above the circular blade 12. The laser guiding device “A” of the present invention comprises a carrier 20 which has a slot 24 defined in an end thereof and the splitter 14 is inserted in the slot 24. Four bolts 25 extend through the carrier 20 and clamp the splitter 14 from two sides of the splitter 14 to fix the carrier 20 to the splitter 14.

The carrier 20 includes a recess 21 defined therein and a notch 211 is defined in a radial direction in an inner periphery of the recess 21 and in communication with the recess 21. The laser generating device 30 is received in the recess 21 and the notch 211. A side hole 22 is defined in the carrier 20 and communicates with the recess 21. A bolt 23 is threadedly engaged with the side hole 22 and in contact with the laser generating device 30 such that the laser generating device 30 is positioned.

A power supply member 40 be connected to the splitter 14 and electrically connected to the laser generating device 30 by a wire 41. A switch 42 is connected to the power supply member 40 such that the user can easily operate the switch 42. The laser generating device 30 emits a laser beam which is located in front of the circular blade 12 so that the user may check the laser beam to guide the cutting process precisely. The laser beam is not covered by the debris and powder from the object to be cut so that the user can proceed the cutting process by the obvious laser beam.

While we have shown and described the embodiment in accordance with the present invention, it should be clear to those skilled in the art that further embodiments may be made without departing from the scope of the present invention.

What is claimed is:

1. A laser guiding device for a table saw machine which includes a base on which a work table is connected, a circular blade rotatably extending through a slot defined through the work table and connected to a splitter, a blade guard pivotably connected to the splitter and located above the circular blade, the laser guiding device comprising:
a carrier in which a laser generating device is received and the carrier adapted to be connected to the splitter, a power supply member adapted to be connected to the splitter and electrically connected to the laser generating device, the laser generating device emitting a laser beam which is adapted to be in front of the circular blade.

2. The laser guiding device as claimed in claim 1, wherein the carrier includes a recess defined therein and the laser generating device is received in the recess.

3. The laser guiding device as claimed in claim 2, wherein a side hole is defined in the carrier and communicates with the recess, a bolt threadedly engaged with the side hole and being in contact with the laser generating device.

4. The laser guiding device as claimed in claim 1, wherein the carrier has a slot defined in an end thereof and the splitter is inserted in the slot, bolts extending through the carrier and securing the carrier to the splitter.
